(19) United States
(12) Patent Application Publication
(10) Pub. No.: US 2012/0290910 A1
(43) Pub. Date: Nov. 15, 2012

(54) RANKING SENTIMENT-RELATED CONTENT USING SENTIMENT AND FACTOR-BASED ANALYSIS OF CONTEXTUALLY-RELEVANT USER-GENERATED DATA

(75) Inventors: Ankesh Kumar, Palo Alto, CA (US); Yogesh Gowdra, Sunnyvale, CA (US); James Ioannidis, San Francisco, CA (US)

(73) Assignee: Searchreviews LLC, Palo Alto, CA (US)

(21) Appl. No.: 13/335,685

(22) Filed: Dec. 22, 2011

Related U.S. Application Data
(63) Continuation-in-part of application No. 13/244,157, filed on Sep. 23, 2011.
Application No. 13/244,157 is a continuation-in-part of application No. 13/105,560, filed on May 11, 2011.

(51) Int. Cl. G06F 17/30; G06F 17/00

(52) U.S. Cl. 715/205; 707/748; 707/E17.009

(57) ABSTRACT

Techniques for ranking sentiment-related content using sentiment and factor-based analysis of contextually-relevant user-generated data is described, including generating a term, the term associated with a keyword and a factor, grouping user-generated content associated with the term, the user-generated content being retrieved by a crawler and stored in a database, assigning a rank to the term, the rank associated with one or more attributes of the user-generated content, and including a link associated with the term in a list, the list comprising a plurality of links associated with a plurality of terms, each of the plurality of terms having an assigned rank.

### CROSS-REFERENCE TO RELATED APPLICATIONS

This application is a continuation-in-part of U.S. patent application Ser. No. 13/244,157, filed Sep. 23, 2011 (Attorney Docket No. SEA-001CIP2), entitled “Sentiment and Factor-Based Analysis in Contextually-Relevant User-Generated Data Management,” which is a continuation-in-part of U.S. patent application Ser. No. 13/105,560, filed May 11, 2011 (Attorney Docket No. SEA-001), entitled “Contextually-Relevant User-Generated Content Management,” and related to co-pending U.S. patent application Ser. No. 13/244,087, filed Sep. 23, 2011 (Attorney Docket No. SEA-001CIP1), entitled “Retargeting Contextually-Relevant User-Generated Data,” and U.S. patent application Ser. No. 13/335,781, filed Dec. 22, 2011 (Attorney Docket No. SEA-001CIP2CIP1), entitled “Providing Sentiment-Related Content Using Sentiment and Factor-Based Analysis of Contextually-Relevant User-Generated Data,” all of which are hereby incorporated by reference in their entirety for all purposes.

### FIELD

The present invention relates generally to computer software, computer program architecture, data and database management and web searching applications. More specifically, techniques for ranking sentiment-related content using sentiment and factor-based analysis of contextually-relevant user-generated data are described.

### BACKGROUND

There are numerous products and services that can be found, sold, licensed, or are otherwise available for perusal via online media such as the Internet and World Wide Web (hereafter “the web”). The widespread distribution of information, data, and content (i.e., text, graphics, video, audio, multi-media, visual, and others) coupled with increasingly powerful processor-based computing devices that are smaller, inexpensive (i.e., able to be purchased by an increasingly larger global population), mobile/portable, and accessible to data networks such as the Internet are creating numerous opportunities to find, research, peruse, and, in many cases, purchase products or services online (i.e., over a data network such as the Internet or the web). However, the proliferation of information has increased the difficulty facing consumers when researching a specific good or service.

Conventionally, there are numerous online providers of general and specific information on products and services, ranging from electronic commerce merchant providers (hereafter “merchants”) to auction operators to specialized sellers (i.e., merchants that cater to specific categories of goods or services). However, when identifying a particular good or service, a consumer (i.e., user) typically sifts through large amounts of information, including product or service descriptions, terms and conditions of a sale or license, and other details generally provided by sellers (i.e., the providers of goods or services, regardless of whether online or offline). Some conventional solutions often rely upon the use of product or service reviews (hereafter “reviews”) that are provided by other prior purchasers. These reviews are often edited, restricted from full viewing, or, in some cases, precluded from being displayed on a given website altogether. Further, other conventional solutions only present reviews that are submitted to a website that is offering the good or service. In other words, the source of reviews that users rely upon for purchasing decisions (e.g., making a dinner reservation at a specific restaurant, purchasing a specific good or service for online purchasing, arranging for travel accommodations, researching a specific good or service for offline purchasing (i.e., at a physical, “brick-and-mortar” store location) are often limited to those provided on a specific website (i.e., the website listing the good or service), thus the quality and value of the review to the user is subsequently limited. Still further, the density and volume of information available on the Internet and the web create significant obstacles to advertisers and marketers seeking to promote specific goods or services to users who may become purchasers.

Using conventional solutions, users are often relegated to finding a given product or service on one website, but then performing extensive searches on other websites in order to evaluate quality, price, and other details before engaging in a transaction. Some conventional solutions present aggregated listings of products or services for sale, but lack reviews. These conventional solutions may provide specification-based comparison capabilities, but typically do not allow for users to compare based on sentiment. Other conventional solutions provide reviews, but do not present opportunities for purchasing a reviewed product or service. Such conventional solutions also typically do not provide users with the ability to search for or compare products and services according to useful content in the reviews. Still other conventional solutions of website providers display both product and/or service listings and reviews, but typically limit the latter to only those provided “organically” (i.e., reviews provided on the website listing the good or service). Consequently, reviews are limited to only those users of the website displaying the good or service for sale, thus limiting the ability of the user to objectively evaluate a given purchase or transaction. Users often search for other user-generated content (e.g., product or service reviews from prior purchasers or customers, guides, editorial articles, and the like), but there is significant difficulty in canvassing the large amounts of information that are made available through various types of media such as websites, social networks, social media, and the like. Many other problems exist with conventional solutions, including improving the effectiveness of online advertising and marketing campaigns, increasing affiliate marketer revenues while also increasing the targeting accuracy of specific campaigns, providing consumers with tools for discovering and comparing products and services based upon sentiments expressed in user-generated content, and the like.

Thus, what is needed is a solution for ranking sentiment-related content using sentiment and factor-based analysis of contextually-relevant user-generated data without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary system for contextually-relevant user-generated data management;

FIG. 2 illustrates another exemplary system for contextually-relevant user-generated data management;

FIG. 3A illustrates an exemplary application architecture for contextually-relevant user-generated data management;

FIG. 3B illustrates an exemplary application architecture for a widget configured to perform content evaluation used in contextually-relevant user-generated data management;

FIG. 3C illustrates an exemplary application architecture for retargeting contextually relevant user-generated data;

FIG. 3D illustrates an exemplary application architecture for sentiment and factor-based analysis in contextually-relevant user-generated data management;

FIG. 4 illustrates an exemplary graphical user interface for contextually-relevant user-generated data management;

FIG. 5 illustrates another exemplary graphical user interface for contextually-relevant user-generated data management;

FIG. 6 illustrates exemplary types of user-generated content;

FIG. 7 illustrates an exemplary data architecture for contextually-relevant user-generated data management;

FIG. 8 illustrates another exemplary data architecture for contextually-relevant user-generated data management;

FIG. 9 illustrates yet another exemplary data architecture for contextually-relevant user-generated data management;

FIG. 10A illustrates an exemplary process for contextually-relevant user-generated data management;

FIG. 10B illustrates another exemplary process for contextually-relevant user-generated data management;

FIG. 11A illustrates a further exemplary process for contextually-relevant user-generated data, management;

FIG. 11B illustrates yet another exemplary process for contextually-relevant user-generated data management;

FIG. 12 illustrates an exemplary computer system suitable for contextually relevant user generated data management;

FIG. 13 illustrates an exemplary process for retargeting contextually relevant user-generated data;

FIG. 14 illustrates an exemplary process for sentiment and factor-based analysis in contextually-relevant user-generated data management;

FIG. 15A illustrates an exemplary process for providing sentiment-related content using sentiment and factor-based analysis in contextually-relevant user-generated data management;

FIG. 15B illustrates an alternative exemplary process for providing sentiment-related content using sentiment and factor-based analysis in contextually-relevant user-generated data management; and

FIG. 15C illustrates an exemplary process for generating a ranked list of terms using sentiment and factor-based analysis in contextually-relevant user-generated data management.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including ASP, ASP.net, .Net framework, Ruby, Ruby on Rails, C, Objective C, C++, C#, Adobe® Integrated Runtime™ (Adobe®AIR™), ActionScript™, FleX™, Lingo™, Java™, Javascript™, Ajax, Perl, COBOL, Fortran, ADA, XML, MXML, HTML, DHTML, XHTML, HTTP; XMPP, PHP, and others. Design, publishing, and other types of applications such as Dreamweaver®, Shockwave®, Flash®, Drupal and Fireworks® may also be used to implement the described techniques. Database management systems (i.e., “DBMS”), search facilities and platforms, web crawlers (i.e., computer programs that automatically or semi-automatically visit, index, archive or copy content from, various websites (hereafter referred to as “crawlers”)), and other features may be implemented using various types of proprietary or open source technologies, including MySQL, Oracle (from Oracle of Redwood Shores, Calif.), Solr and Nutch from The Apache Software. Foundation of Forest Hill, Md., among others and without limitation. The described techniques may be varied and are not limited to the examples or descriptions provided.

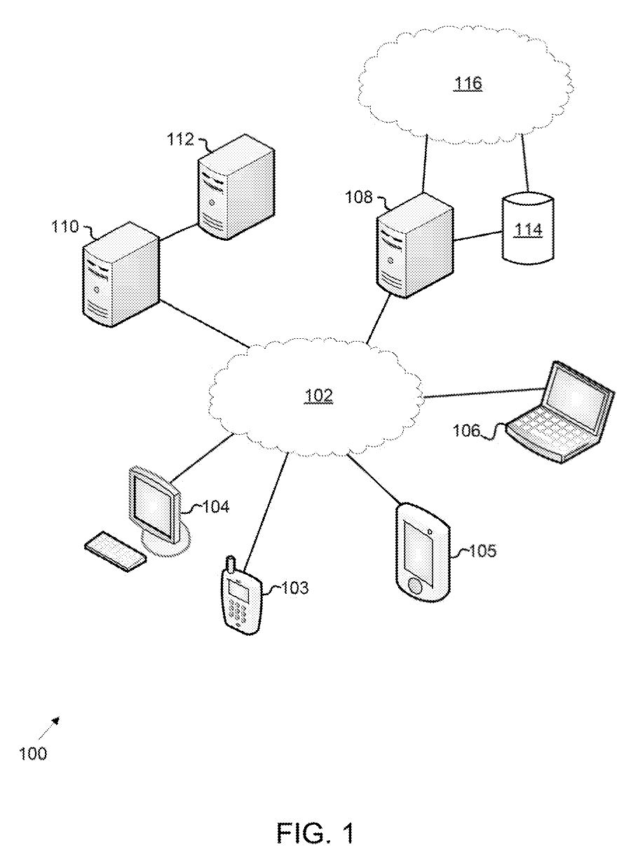

FIG. 1 illustrates an exemplary system for contextually-relevant user-generated data management. Here, system 100 includes network 102, clients 104-106, servers 108-112, repository 114, and computing cloud 116. In some examples, the number, type, configuration, and data communication protocols shown may be varied and are not limited to the examples described. As shown here, clients 104-106 and servers 108-112 may be configured to implement, install, or host the described techniques as applications. Clients 104-106, in some examples, may be implemented as any type of computing device that is configured to transmit and receive wired or wireless data. For example, client 103 may be a smart phone or personal computing device such as an iPod®, iTouch®, iPad®, or iPhone®, such as those developed by Apple, Inc. of Cupertino, Calif. Clients 104-106 may also be implemented as a laptop or desktop computer, but may also be implemented as a tablet computing device such as that shown for client 105. However, in other examples, clients 104-106 may be implemented differently and are not limited to any of the specific examples shown or described.

As shown here, data may be stored in repository 114, which may be implemented as any type of data storage facility such as a database, data warehouse, data mart, storage area network (SAN), redundant array of independent disks (RAID), or other type of hardware, software, firmware, circuitry, or a combination thereof configured to store, retrieve, organize, access, or perform other operations. Likewise, clients 104-106 and servers 108-112 may be implemented as any type of computing device, hardware, software, firmware, circuitry, or a combination thereof for purposes of providing computational and processing capabilities for the techniques described herein. For example, server 108 may be used with repository 114 to host an application or set of applications that are configured to perform the described techniques for open application lifecycle management using the framework described below. Data associated with any operation may be stored, retrieved, or accessed from repository 114. Still further, computing cloud 116 may be used to, provide processing and/or storage resources beyond those provided by server 108 or a cluster of servers (e.g., servers 110-112) in order to install, implement, or otherwise run program instructions for the described techniques. As described, the techniques for open application lifecycle management may be implemented as a standalone application on any of clients 104-106 or servers 108-112. In some examples, if a database management system (i.e., DBMS; not shown) is used with repository 114, the described techniques may also be implemented as an application stored therein.

As shown, clients 104-106, servers 108-112, computing cloud 116, and/or a combination thereof may also be used to implement the described techniques as a distributed application. Different techniques may be used to implement the described techniques as a distributed application, including deployment as software-as-a-service (i.e., SaaS) or as a distributed application in accordance with specifications such as WSDL (i.e., web services distributed language). Other specifications, protocols, formats, or architectures may be used to implement the described techniques, without limitation, and are not limited to the examples shown and described. Further, system 100 and the above-described elements may be varied and are not limited to those shown and described.

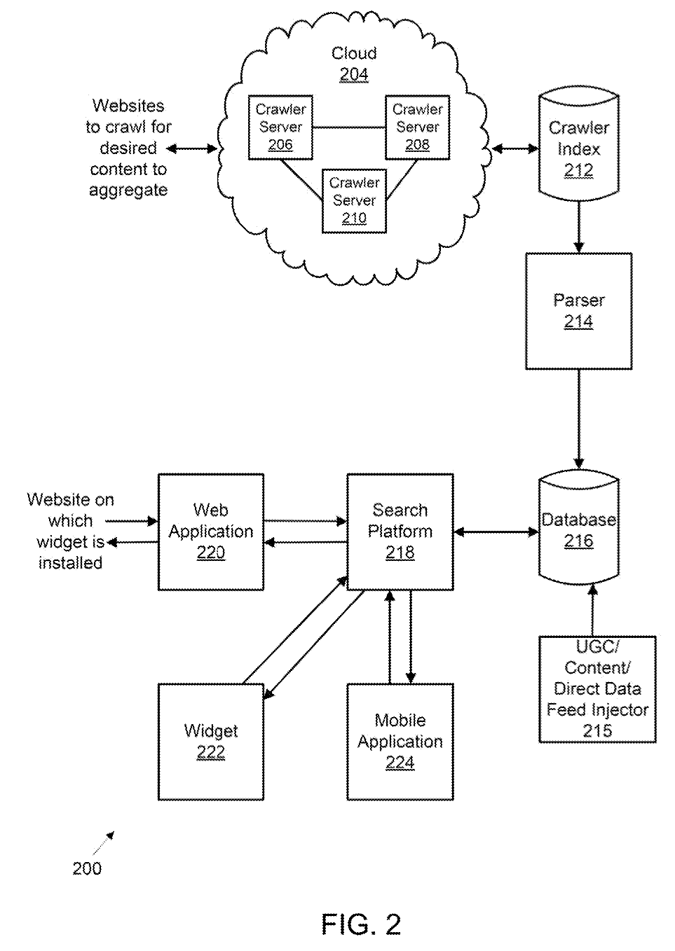

FIG. 2 illustrates another exemplary system for contextually-relevant user-generated data management. Here, system 200 includes cloud 204, crawler servers 206-210, crawler index database 212, parser 214, user-generated content/content/direct data feed injector 215, database 216, search platform 218, web application 220, widget 222, and mobile application 224. In some examples, system 200 may refer to an application architecture or network topology that is used to implement the described techniques. The shapes, sizes; quantity, and configuration of elements shown (e.g., cloud 204, crawler servers 206-210, crawler index database 212; parser 214, user-generated content/content/direct data feed injector 215, database 216, search platform 218, web application 220, widget 222, and mobile application 224) have no relative importance and may be modified for various configurations or implementations beyond those examples shown and described. For example, cloud 204 may represent one or more distributed computing networks that are provided by multiple, disparate providers and, when combined, provide for a computing cloud (e.g., cloud 204). As another example, crawler servers 206-210 may be implemented using any type of web crawling computer program, software, or application (hereafter “application”) without limitation as to the type, make, build, revision, version, or other aspects. As an example, Nutch from The Apache Software Foundation may be used to implement one or more of crawler servers 206-210. As another example, Solr from The Apache Software Foundation may also be used to implement Search Platform 218. In other examples, different software products and technologies may be used to implement one or more of the elements shown, without limitation to those described.

In some examples, websites are crawled by crawler servers 206-210, which are hosted in cloud 204. Types of information and data gathered by crawler servers 206-210 may include product and service reviews, user-generated content, or other content, which may be stored in database 216. Another exemplary technique for gathering (i.e., crawling, collecting, caching, copying, or otherwise obtaining) content across the web or Internet may include using a data feed (e.g., direct, indirect, or otherwise), for example, an application programming interface (API) with a content website. Data transmitted via hypertext transfer protocol (e.g., “HTTP”), both secure (i.e., HTTPS) and insecure (i.e., HTTP) may be used to inject content directly into database 216. As an example, UGC/Content/direct data feed injector 215 may be used to “inject” or add, store, cache, copy, or otherwise add user-generated or other content directly (or indirectly) to database 216. In other words, contextually-relevant user-generated content may be obtained by using various techniques, including crawler servers 206-210, data feeds, and other techniques. Data (e.g., content accessed, retrieved, indexed, copied, cached, or otherwise operated upon, actively or passively, by crawler servers 206-210) yielded from crawler servers 206-210 are passed to crawler index database 212. Alternatively, crawler servers 206-210 may be in data communication with crawler applications or clients (not shown) that are executed on websites or clients. Here, content retrieved from crawler servers 206-210 may be stored in database 216, which may be implemented using various types of database management systems and schemas. In some examples, content may be any type of data or information retrieved or otherwise generated by crawler servers 206-210 from websites crawled. As an example of content, reviews relating to products or services may be indexed, copied, and cached/stored in database 216. Item descriptions (e.g., descriptions of products or services offered for sale on one or more websites crawled by crawler servers 206-210) may also be stored in database 216. Other types of content such as attributes associated with content or user-generated content of any type may also be stored in database 216. For example, MySQL may be used to implemented database 216, which may also include one or more databases or use a monolithic or distributed storage facility, such as networked storage systems, storage area networks (SAN), network attached storage (NAS), and the like.

As shown here, website (not shown) on which widget 222 is installed may be accessed by web application 220 (which may be implemented by any web application or web application server without regard to any specific technology, platform, standard, version, developer, build, or revision), which retrieves data (e.g., invoked call from the widget including a hyperlink containing anchor text or other information that may indicate how content is to be retrieved from crawler index database 212). Widget 222 is shown and described in greater detail below, but generally refers to any application that is configured to reside on a website to implement the described techniques. Retrieved information is managed by search platform 218, which can also send or receive data to/from mobile application 224. In some examples, mobile application 224 may be any type of application that is downloaded, installed, or otherwise implemented on a mobile computing device of any type, including smart phones, personal digital assistants (PDAs), mobile phones, cell phones, notebook computers, laptop computers, tablet computing devices (e.g., iPad™ from Apple, Inc., Xoom™ from Motorola, Inc., among others), and the like, without limitation. In other examples, system 200 and any of the above-described elements may be varied in design, configuration, topology, function, or structure, without limitation to the examples shown and described.

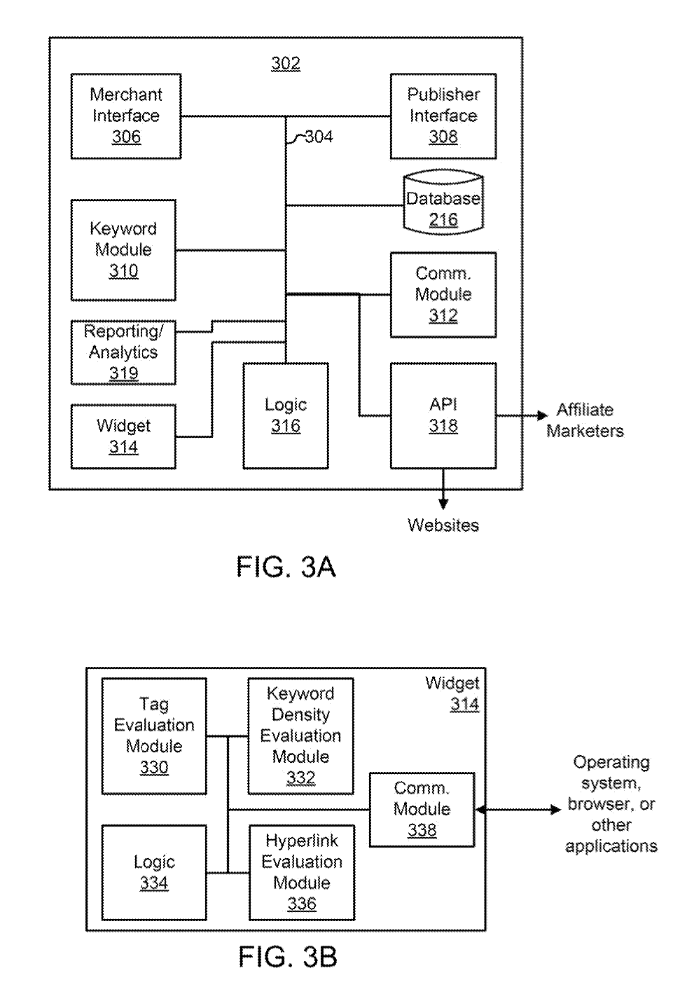

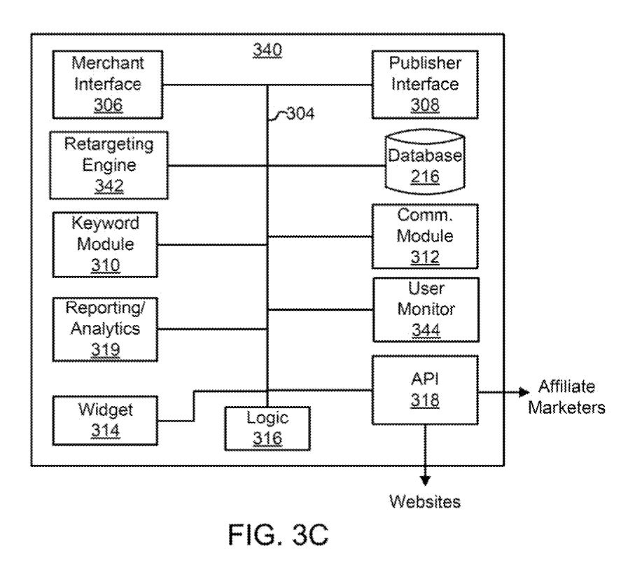

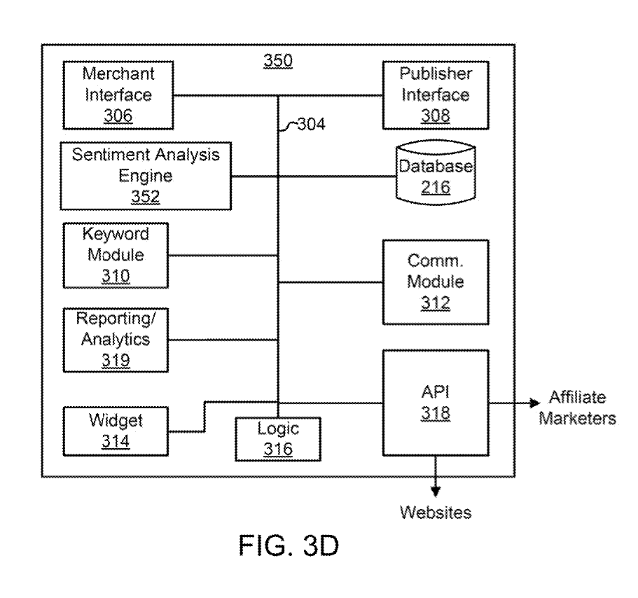

FIG. 3A illustrates an exemplary application architecture for contextually-relevant user-generated data management. Here, application 302 includes data communication bus (hereafter “bus”) 304, merchant interface module 306, publisher interface 308, keyword module 310, communications module 312, database 216, widget (i.e., content evaluation module) 314, logic 316, application programming interface (hereafter “API”) 318, and reporting/analytics module 319. Like-numbered elements may refer to previously-described elements in connection with other drawings, but are provided here for purposes of illustration. For example, database 216 may be implemented similarly to the data repository, structure, or function described in connection with FIG. 2. Database 216 may be used to store reviews, item descriptions, service descriptions, attributes (in, for example, HTML, XML, or other formatting languages), or other user-generated content (hereafter “UGC”) or the like. In other examples, database 216 may be implemented differently and is not limited to the example shown and described.

Here, application 302 may be used to implement the described techniques for contextually-relevant user-generated data management. Merchant interface 306 may be used to communicate with website operators that are selling products or services and which is intended for integration with application 302 in order to receive contextually-relevant user-generated content such as reviews associated with items being sold on, a, given merchant's website. Likewise, publisher interface 308 may be used to enable data communication between application 302 using, for example, API 318 in order to exchange data with websites using contextually-relevant user-generated content or affiliate marketers seeking to integrate advertising data networks with, for example, UGC provided by application 302.

As shown, keyword module 310 may be implemented to enable application 302 to search, retrieve, and return UGC from database 216 to websites (not shown) that use or have an embedded widget (i.e., widget 314). In some examples, application 302, with the exception of widget 314, may be implemented on a server, server cluster, network, computing cloud (hereafter “cloud”), or other processor facility. Widget 314 may be implemented using various types of object-oriented programming languages such as JavaScript, Java®, C++, C#, C, or others, without limitation. As an example, JavaScript®-based program code may be used to embed a widget on a given page using the following format and syntax:

<script type=“text/javascript” charset=“utf-8”
src=“http://searchreviews.com/widget/widget.jsp?pId=E73VRpaZdYs=”>
</script>

At a given location the following reference line may be included in order to embed a widget on a specific web page, providing a keyword for which content is to be retrieved (i.e., “KEYWORD” should be replaced with a product, service, or item name or descriptive keyword):

<a href=“http://searchreviews.com” title=“find reviews”
class=“searchReviewsLink”>KEYWORD Reviews</a>

The above-referenced examples are provided for purposes of illustration and other implementations of similar-functioning program code may be envisioned and used, without limitation to any specific programming or formatting language, syntax, or form. In other examples, keywords may be extracted from a given page element (e.g., style sheet, field, area, or the like) and used to configure widget 314 to extract UGC or other content from a specific source. In still other examples, filters may be used, by either logging into a service system administration interface or using reporting/analytics module 319. Reporting/analytics module 319 may also be used to generate reports for various campaign, metric, performance, or other functions or results of application 302.

When implemented widget 314 may be configured to generate an identifier that is specific and unique to a given website using one or more various techniques. For example, widget 314 may be programmed or “coded” to identify keywords in content on a given electronic commerce (hereafter “e-commerce”) website in order to determine what product reviews should be provided for a particular item. Widget 314 may also be configured to identify keywords by evaluating hyperlinks that are transmitted to application 302 in which anchor text includes keywords that can be used to match or “pair” content extracted from database 216. In other examples, widget 314 may be used to evaluate website content to determine keyword density and, for example, generate an identifier for a given content website based on identifying a specific keyword receiving the highest number of occurrences. For example, a content-oriented website that is being provided by a publisher may have an editorial article regarding a given good or service. In some examples, an article may have a title, which has been formatted using, for example, HTML, HTML5, XML, or another formatting language in order to provide a header tag that widget 314 can identify and use to generate the identifier. In other examples, a title or header tag may not be present and widget 314 can instead evaluate the content to determine keyword density and, in so doing, a keyword that occurs with the highest number of occurrences within the article. Regardless of how the identifier is generated, widget 314 invokes a call to application 302 with the identifier and, subsequently, logic 316 generates a signal to database 216 to search for, retrieve, format, and return content or UGC to widget 314 using, in some examples, communications module 312 and API 318. In other examples, widget 314 may be implemented differently and is not limited to the examples shown and described.

Here, when content or UGC is returned to widget 314, websites having an embedded widget (i.e., widget 314) may then present (i.e., display) information and/or data using various techniques, some of which are described below. In other examples, content or UGC retrieved from database 216 may be sent via a data feed to affiliate marketers (not shown). Further, a data feed may be provided that also serves embed code for widget 314 in order to allow affiliate marketers to deploy widget 314 at one or more locations on affiliate websites. Still further, other implementations of application 302 and the elements shown and described may occur without limitation to the specific examples shown and described.

FIG. 3B illustrates an exemplary application architecture for a widget configured to perform content evaluation used in contextually-relevant user-generated data management. In some examples, widget 314 may be implemented similarly to that like-named and numbered element as shown and described above in connection with FIG. 3A. Here, widget 314 includes tag evaluation module 330, keyword density evaluation module 332, logic 334, hyperlink evaluation module 336, and communications module 338. As shown, logic 334 may be configured to manage one or more of tag evaluation module 330, keyword density evaluation module 332, hyperlink evaluation module 336, and communications module 338.

Tag evaluation module 330 may be configured to evaluate one or more tags found within a document (i.e., a file that provides content (e.g., text, images, links, and the like) and formatting instructions to a browser for rendering purposes). In some examples, tag evaluation module 330 may evaluate different types of tags in order to identify a keyword that may be used to retrieve UGC from, for example, database 216, and present the retrieved content on the website on which widget 314 is embedded. An example of a tag type that could be directed for evaluation by logic 334 may be header tags in which keywords associated with a given product or services are described. As another example, larger HTML tags may be evaluated to identify keywords. In some examples, larger tags may include header tags that can be evaluated in order to identify potential keywords. Likewise, larger HTML tags may also be evaluated to identify any keywords that can be used to search for UGC or other types of content.

In other examples, keyword density evaluation module 332 may be used to evaluate content, as described above in connection with FIG. 3A, to identify a keyword density that is generated and quantitatively and/or qualitatively represented by an identifier transmitted by widget 314 to application 302.

Further, hyperlink evaluation module 336 may be used to evaluate domain names or uniform resource locators (i.e., URLs) or addresses associated with the content on which widget 314 is embedded and configured to generate an identifier and request for UGC or other content. As shown, communications module 332 may be an application that is implemented to format data transferred between widget 314 and other elements according to various types of data communication and transport protocols (e.g., HTTP, TCP, UDP, and the like). In other examples, widget 314 and the elements shown and described above may be implemented differently in function, structure, configuration, or other aspects and are not limited to those shown and described.

FIG. 3C illustrates an exemplary application architecture for retargeting contextually relevant user-generated data. Here, application 340 includes database 216 (FIG. 2), data communication bus (hereafter “bus”) 304, merchant interface module 306, publisher interface 308, keyword module 310, communications module 312, widget (e.g., “content evaluation module”) 314, logic 316, application programming interface (hereafter “API”) 318, reporting/analytics module 319, retargeting engine 342, and, user monitor 344. Like-numbered elements may refer to previously-described elements in connection with other drawings, but are provided here for purposes of illustration. Further, size, shape, layout, or design of application 340 and the various elements shown (e.g., database 216, bus 304, merchant interface module 306, publisher interface 308, keyword module 310, communications module 312, widget 314, logic 316, API 318, reporting/analytics module 319, retargeting engine 342, and user monitor 344) are not intended to be limiting or restrictive with regard to either function, structure, features, or other aspects described.

In some examples, application 340 may be configured to retarget content such as reviews (e.g., consumer reviews directed to goods, products, services, properties, hotels, or any item that may be reviewed) with regard to various factors, attributes, sentiments (i.e., attributes associated with a given user's affinity or perception of a given item) based on observed behavior. As shown, user monitor 344 may be a software module that is configured to observe behavior of a browser (i.e., a user who is using a browser to navigate to a given website, destination or address to find information, engage in a transaction, purchase an item, or perform another action, without limitation) using, for example, a “cookie” or other file. A cookie, in some examples, may be a plain text file that is configured to store information about a user's behavior with regard to a browser and actions that were performed in connection with such. User monitor 344 may be configured to access, retrieve, and analyze data stored in a cookie (not shown) in order to determine the type of content (e.g., reviews for a particular item or service) to request, retrieve, push, or otherwise access for display using widget 314, as described above.

Data from user monitor 344 regarding observed behavior or actions of a user on a given website, address, or destination may be communicated (i.e., transferred) to retargeting engine 342 over bus 304. Data transferred may indicate that a user has navigated from a given website to another website. However, user monitor 344 and logic 316 may be configured to determine a pattern from the data stored in a cookie in order to identify subsequent content (e.g., other reviews) to be displayed using widget 314. In other words, retargeting engine 342 may be configured to present other reviews or content on a display or graphical user interface thereupon using widget 314 despite a user having navigated a browser to another destination. In some examples, application 340 may be configured to store data in a file (e.g., cookie) in a format that may be read to determine a pattern or history of behavior associated with a user's navigation of a web browser. A file may be stored in various types of formats that may be read using data schema, such as JavaScript Object Notation (JSON), among others. Using object-oriented programming languages such as Java, JavaScript, and others, a cookie may be constructed and installed on a computer (i.e., operating system) in data communication with a web browsing application (i.e., browser) and used to provide data, including control signals, to retargeting engine 342. In other examples, a cookie may also be installed as part of or separate from widget 314.

As an example, a user may direct (i.e., navigate or point) a browser to a given destination to perform research, prior to purchasing, a pair of swim goggles. A user may be interested in various factors, parameters, or attributes (hereafter “factors”) such as price, color, make, model, manufacturer, performance, reviews, ratings, and the like. Before engaging in a transaction, a user may be interested in performing research to gather information regarding these factors and, in some examples, use reviews from other purchasers to further refine a selection prior to purchase. As the user navigates through different websites, addresses, or destinations, a cookie or similar file may be used to gather information and data regarding the user's behavior and history of content views. This data stored to, for example, a plain text file (e.g., cookie) may then be used to identify reviews to be presented to the user that are compared and matched for similarities to the factors that are observed to be of interest for the user. As reviews provide content that may be useful for a user when researching a purchase, hyperlinks may also be embedded in order to allow a user to quickly navigate to a website or web page where a transaction may be performed.

Here, for example, if user monitor 344 has detected that the user was viewing swim goggles of a given manufacturer, subsequent content such as reviews of products produced by the same manufacturer may be presented by retargeting engine 342. Detecting that a user has navigated off or away from a given website, address, or destination, user monitor 344 may also be configured to detect when similar behavior has begun on a different website, address, or destination and deliver content (e.g., reviews) based on the pattern or history of behavior, among other factors. In other examples, browsing behavior may be disrupted by other events such as a computer being turned off, a power outage or loss/removal of power from a given computing device, stopping an application (e.g., browser or web browsing application), or others. However, a cookie may be used to collect historical, behavioral, or other types of information for further use when browsing behavior has been detected again. By using, the described techniques, content (e.g., stored in database 216 and retrieved by one or more crawlers (i.e., web crawling applications) may be retargeted on a more accurate basis in order to encourage higher click through rates as well as generate greater revenue for more successful types of content delivery campaigns (e.g., online advertising or marketing campaigns). In some examples, content may also be displayed based on rankings performed to determine reviews that may be of higher relevance based on the user's behavior. Further, by using content such as reviews that are hyperlinked to websites, addresses, or destinations of the original posting, users may be encouraged to purchase items or engage in commercial transactions due to the shared attributes exhibited between the review and the user. In other examples, application 340 and the elements shown and described above may be implemented differently in function, structure, configuration, or other aspects and are not limited to those shown and described.

FIG. 3D illustrates an exemplary application architecture for sentiment and factor-based analysis in contextually-relevant user-generated data management. Here, application 350 includes database 216 (FIG. 2), data communication bus (hereafter “bus”) 304, merchant interface module 306, publisher interface 308, keyword module 310, communications module 312, widget (e.g., “content evaluation module”) 314, logic 316, application programming interface (hereafter “API”) 318, reporting/analytics module 319, and sentiment analysis engine 352. Like-numbered elements may refer to previously-described elements in connection with other drawings, but are provided here for purposes of illustration. Further, size, shape, layout, or design of application 350 and the various elements shown (e.g., database 216, bus 304, merchant interface module 306, publisher interface 308, keyword module 310, communications module 312, widget 314, logic 316, API 318, reporting/analytics module 319, sentiment analysis engine 352, etc.) are not intended to be limiting or restrictive with regard to either function, structure, features, or other aspects described.

As shown, application 350 may be configured to identify one or more factors by performing sentiment analysis on reviews of products that a given user is viewing on a display of a user interface. In some examples, reviews or other types of content may be gathered (e.g., copied by one or more crawlers or web crawling applications) and stored in database 216. Using sentiment analysis engine 352, content (e.g., reviews) may be evaluated using, in some examples, natural language processing (“NLP”) to identify features, sentiments (e.g., “comfortable,” “nice,” “warm,” “cool,” “hot,” “great,” “poor,” and other attributes, without limitation), or other factors that are associated with a given item, service, good, product, or subject matter associated with a given user's research.

Using sentiment analysis engine 352 and keyword module 310, terms may be constructed that are used to generate “landing pages” or websites or web pages where content related to the terms may be presented by rankings, order, relevance, clickthrough or conversion rates, or other characteristics, without limitation. Sentiment analysis engine 352 may be configured to embed a given term (e.g., keyword+sentiments (i.e., factors)) in an address associated with a landing page. For example, logic 316 may be configured to identify terms created by sentiment analysis engine 352 and format them for inclusion in an address or pointer such as a uniform resource locator (“URL”) for a landing page. In some examples, spaces in a term may be replaced with a hyphen or unusual characters may be removed in order to format a given term for inclusion in a URL. In other examples, terms may be formatted differently in order to include both sentiment data and keywords in an address or pointer that may be configured to direct a browser to a destination (e.g., a landing page) where related content can be displayed in an aggregate manner.

As shown, application 350 may be configured to store data associated with reviews or other content in database 216. In some examples, reviews or content may be received from crawlers via API 318. Based on evaluating keyword density of the reviews or content by keyword module 310, “buckets” or groupings may be created. Using NLP or other software processing applications, techniques, or formats, keywords may be extracted by keyword module 310 and factors identified by sentiment analysis engine 352. Once determined the results of the processing may be stored in database 216 using various types of database formats, types, or schema (e.g., SOLR™, DB, or others, without limitation). Landing pages, subsequently, may be created and then used to aggregate content such as reviews using the stored terms (e.g., keywords+sentiment analysis results). As shown, application 350 may be configured to automatically, perform sentiment analysis in order to generate results that may be used to identify content for aggregation on a landing page and, when observed user behavior initiates a request, directs a browser to the page to present (i.e., display) aggregated, contextually-relevant content. In other examples, application 350 may be configured to perform the described techniques semi-automatically or manually (i.e., based on user input). In other examples, application 350 and the elements shown and described above may be implemented differently in function, structure, configuration, or other aspects and are not limited to those shown and described.

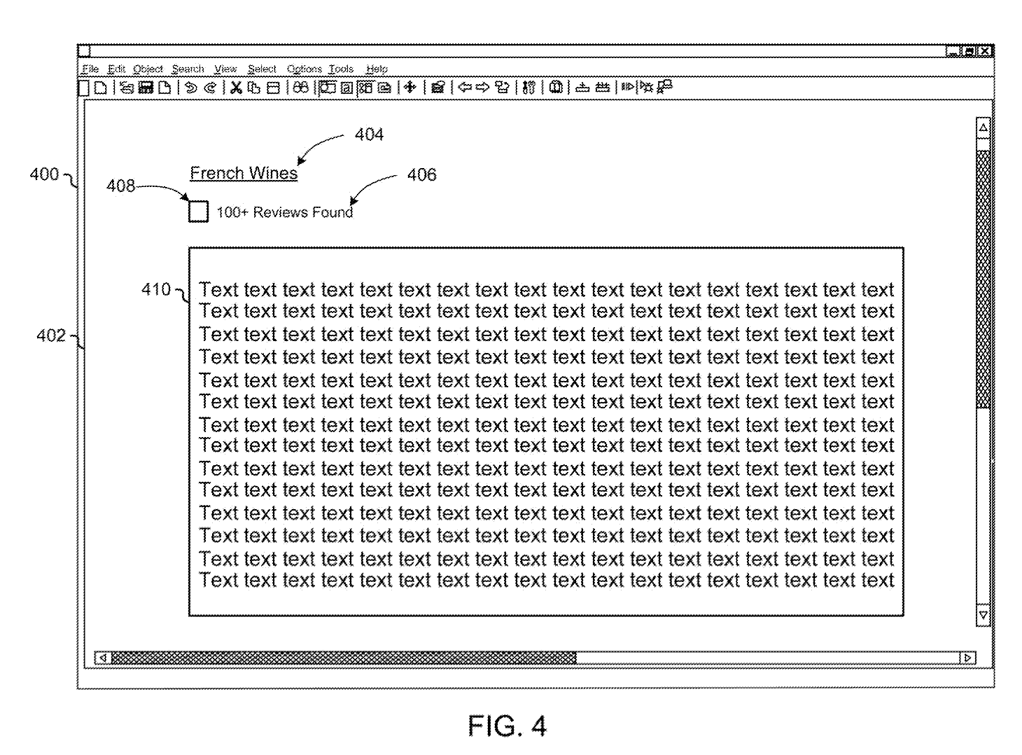

FIG. 4 illustrates an exemplary graphical user interface for contextually-relevant user-generated data management. Here, a graphical user interface (i.e., GUI or “interface,” which may be used interchangeably without restriction) 400 is shown, including panel 402, title 404, widget 408, widget indicator 406, and content panel 410. In some examples, widget 408, as described above in connection with widget 314 of FIGS. 3A and 3B, may be embedded on a website that is provided by a publisher (i.e., an entity, organization, or individual) that is thematically organized around various types of subject matter (e.g., categorical, industrial classifications, or others) or activities (e.g., e-commerce, product reviews, and others). Further, a tracking code may be placed within a hyperlink provided by an c-commerce merchant (e.g., an online retailer, seller, buyer, auction operator, or the like) and rewritten during the embedding process in order to provide track user clickthrough (i.e., an event that happens when an interaction with a hyperlink occurs) rates and conversions to purchases. For example, a hyperlink provided by merchant, publisher, advertisers, affiliate marketer, or other entity, individual or organization may be originally formatted using the hypertext transfer protocol (i.e., HTTP) as:

http://wvvw.yogaaccessories.com/Yoga-Headband_p_{—}121385.html

However, this hyperlink may be rewritten as:

http://www.pntrs.com/t/176559220765?url=http%3A%2F%2F-
www.yogaaccessories.com%2FYoga-Headband_p_121385.html&sid=

The rewritten hyperlink above is configured to direct the user's browser back to the original UGC or other content using a redirected address that includes a tracking code that may be tracked by advertisers or marketers for purposes of reconciling revenue or monies earned by clickthroughs and conversions to purchase transactions. Other forms and formats of tracking codes, addresses, and URLs may be used and are not restricted to the examples shown and described above.

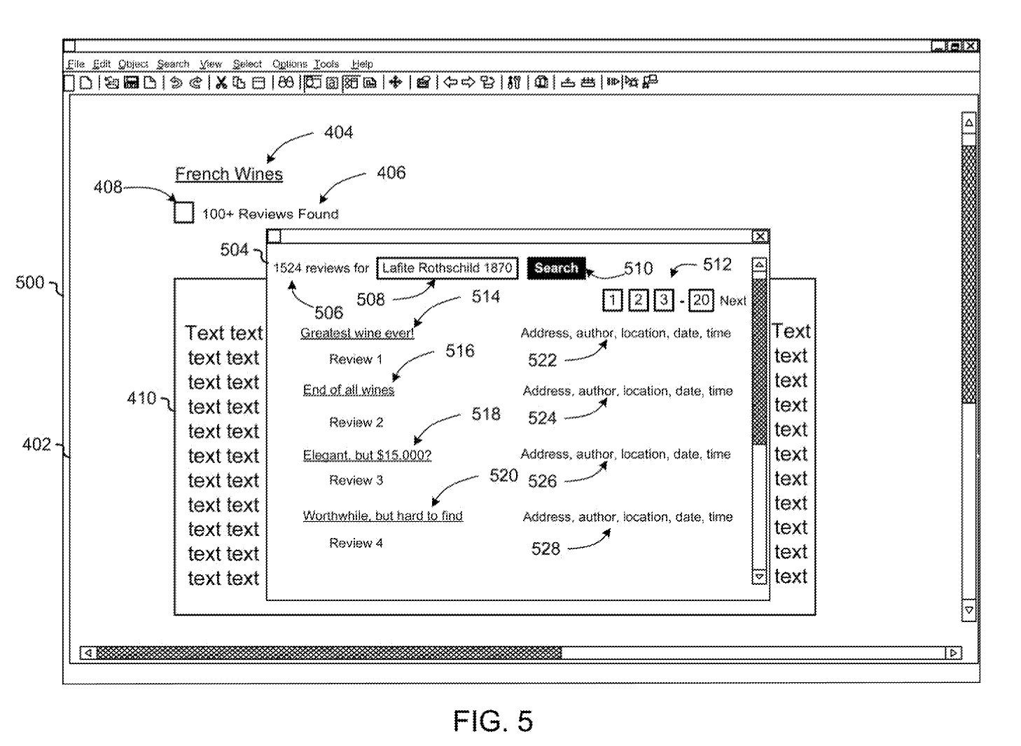

In some examples, widget 408 may be accompanied by widget indicator 406, which may be used to provide a qualitative reference for the number of other items (i.e., UGC, product reviews, service reviews, item descriptions, or other content) found that, when widget 408 is invoked, may be viewed. In other examples, widget indicator 406 may be implemented apart from or together with widget 408. For example, widget 408 may include an image that identifies, qualitatively, the number of items found by widget 408 and application 302 (FIG. 3A). In other examples, widget 408 may be a graphical or design logo that is used to identify a feature provided by widget 408 in order to retrieve UGC (e.g., reviews, item descriptions, and the like). When invoked, widget 408 may be configured to present retrieved UGC and other content as an overlay to content panel 410, as shown and described in FIG. 5. In other examples, interface 400 may be implemented differently and is not limited in configuration, layout, design, functionality, appearance, or any other aspect as shown in the example provided.

FIG. 5 illustrates another exemplary graphical user interface for contextually-relevant user-generated data management. Here, interface 500 is shown with title 404, widget 408, widget indicator 406, content panel 410, display 504, quantity indicator 506, search field 508, search submission button 510, page index 512, items 514-520, and 5: details 522-528. In some examples, when widget 408 is invoked by a user interaction (e.g., clicking on a keyboard button, hovering an icon over widget 408 and clicking a button or invoking another human-computing interface function, or others), display 504 may be rendered to appear, presenting content retrieved from application 302 (FIG. 3A) and database 216, which was retrieved by crawling websites other than that associated with the content presented in content panel 410. In some examples, display 504 may be rendered using manual or system-entered parameters, tags, or attributes such that it overlays content panel 410. Various types of techniques, such as the use of inline frames and others, may be used to, render display 504. Another exemplary technique for rendering a display may the use of JavaScript® for rendering purposes, utilizing data provided through an API (e.g., API 318 (FIG. 3A)). For example, data, information, and parameters regarding the layout, design, location, position, or other attributes of a given display may be sent over a data communication link such as API 318 in order to render display 504. When presented, display 504 may be configured to present UGC or other content that is retrieved using the techniques described. For example, while reading an article about French wines in content panel 410, a user invokes widget 408 may clicking on the icon associated therewith or on widget indicator 406, which presents display 504. Entering a search term (e.g., “Lafite Rothschild 1870”) in search field 508 and using a human-computing interface (hereafter “HCI”) device such as a mouse or keyboard to initiate the search by clicking on search submission button 510, display 504 may be modified to present page index 512, items 514-420, and details 522-528, which may be associated with individual reviews of the given wine sought, presenting content retrieved from crawler servers 206-210 (FIG. 2) and stored in database 216. As shown, interface 500 and display 504 are an example of how widget 314, when invoked, may present contextually-relevant user-generated content. In other examples, display of data and information may be presented differently and is not limited to the examples shown and described.

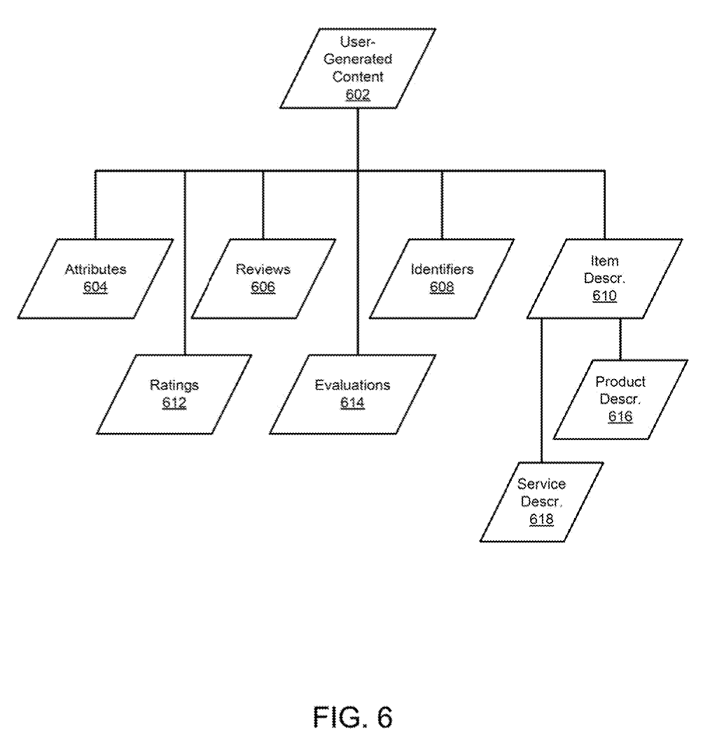

FIG. 6 illustrates exemplary types of user-generated content. Here, different examples of user-generated content 602 are shown, including attributes 604, reviews 606, identifiers 608, item description 610, ratings 612, and evaluations 614. Other types of content may be included in user-generated content 602, including content that is entirely or partially generated by a user. Other types or categories of information or data may be referenced as, although not shown, user-generated content 602, without limitation to the examples shown and described.

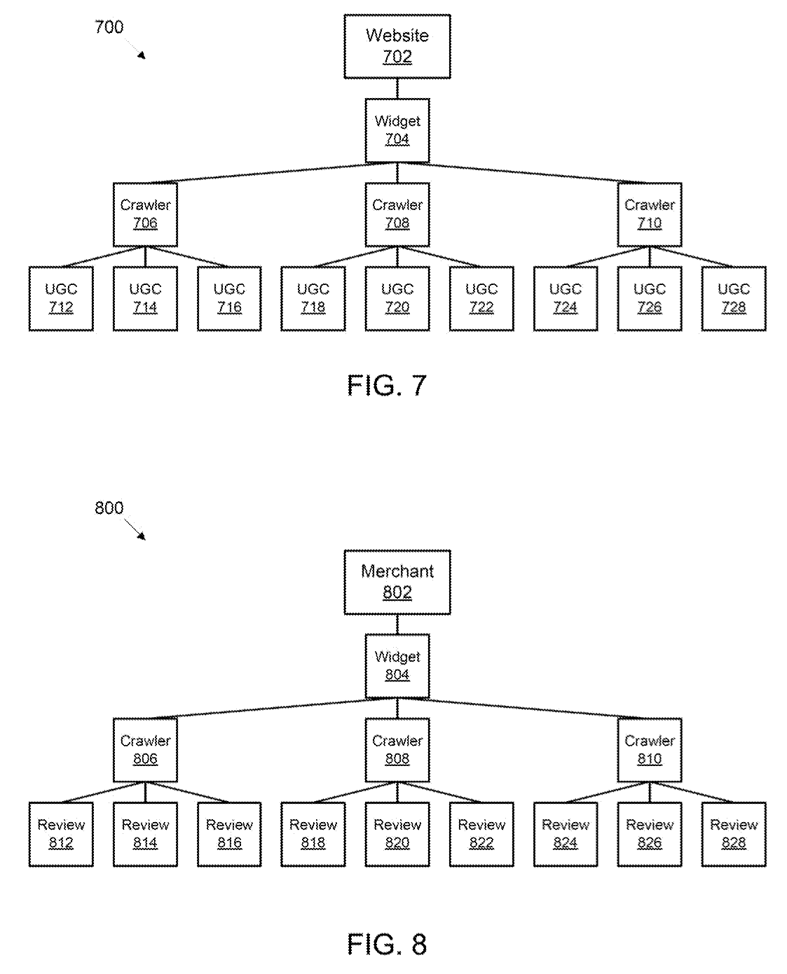

FIG. 7 illustrates an exemplary data architecture for contextually-relevant user-generated data management. Here, architecture 700 includes website 702, widget 704, crawlers 706-710, and UGC 712-728. In some examples, widget 704 is embedded on website 702 and, using crawlers 706-710, UGC 712-728 is sought, evaluated, indexed, cached, copied, and/or stored. No limitation is intended with regard to the numerical structure, hierarchy, size, or shapes of the elements shown, which may be varied in number, function, or other aspects.

FIG. 8 illustrates another exemplary data architecture for contextually-relevant user-generated data management. Here, architecture 800 may be modified to be contextually relevant to an e-commerce application. As shown, architecture 800 may be configured to include a merchant website (i.e., a website from which users may engage in various types of e-commerce transactions (e.g., sales, purchases, auctions, transfers, licenses, or the like), without limitation) 802, widget 804, crawlers 806-810, and reviews 812-814. Similar to FIG. 7, crawlers (i.e., crawler servers 206-210 (FIG. 2)) 812-828 may be configured to crawl websites that are unrelated to merchant website 802. For products or services sold on merchant website 802, substantial value for the website operator, marketers, advertisers, and users by presenting content (i.e., reviews 812-828) gathered (i.e., searched, evaluated, indexed, cached, copied, and/or stored) by crawlers 806-810 from various websites. In order to implement widget 804, widget embed codes (not shown) may be used to “pair” or match widgets to specific products, services or items. Using a widget embed code, which may be an HTML, XML, or other type of tag or code embedded in an address or URL, widget 804 may be embedded on a web page, for example, that display UGC or other content associated with the content of merchant website 802. Widget embed codes may be used, in some examples, by merchants, publishers, advertisers, or others entities, individuals, or organizations to include widgets in data feeds (i.e., provided via APIs or the like) with product, service or item descriptions for display in various forms and formats (e.g., articles, movies, videos, audio, or multimedia) along with widgets that, when invoked, can provide contextually-relevant user-generated content. For example, merchant product data feeds may be provided by application 302 using API 318. Product data feeds may include embedded codes that determine how to parse, render, and display a given widget's content. Embedded within a merchant product data feed (not shown) may be a widget embed code that provides data to parser 214 (FIG. 2) that, when invoked, indicates what content should be retrieved and displayed by widget 314. In other examples, widget embed codes may be implemented differently and are not limited to the examples described.

In some examples, reviews 812-828 may be entirely or partially gathered from websites that do not share a domain model or are otherwise unrelated to merchant website 802. Although widget 804 may be modified by entering rules to guide or direct crawlers 806-810 to certain websites, it may also be configured to find reviews 812-828 from as many (or as few) other websites as those available to crawlers 806-810: The presentation of reviews using a format similar to that shown and described above in connection with FIG. 5 provides a valuable opportunity for users to remain within the context of a current activity (e.g., reading an article) and engage in other contextually-relevant activities such as reading product or service reviews aggregated from various sources and, in some examples, engage in commercial transactions to purchase the product or service. In other examples, architecture 800 may be varied in design, layout, configuration, and other aspects without limitation to the examples shown and described.

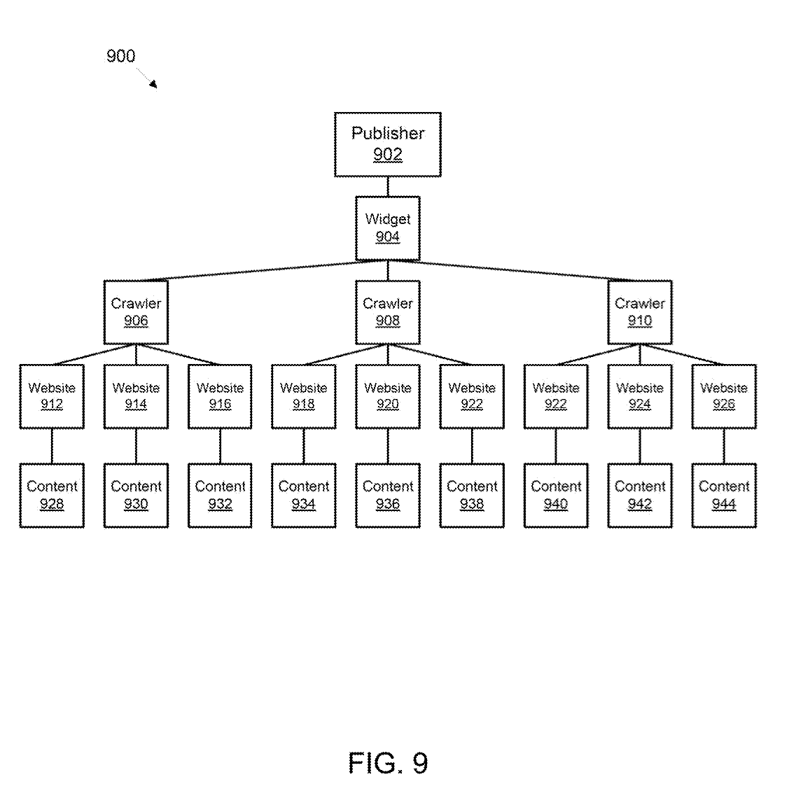

FIG. 9 illustrates yet another exemplary data architecture for contextually-relevant user-generated data management. Here, architecture 900 includes publisher website 902, widget 904, crawlers 906-910, crawled websites 912-926, and content 928-944. In some examples, publisher website 902 may be a website that provides content, but does not permit access to transactions (e.g., e-commerce transactions for purchasing products, services, or other items) because it provides only content for reading. By embedding program code for widget 904 onto publisher website 902, crawlers 906-910 may be directed to crawl (i.e., search, access, index, cache, copy, and perform other operations on) websites 912-926 in order to locate content 928-944. Content 928-944 may be UGC or other types of content, without limitation. Further, the amount or quantity of crawlers 906-910, websites 912-926, and content 928-944 may be varied and are not limited to the examples shown and described. Still further, architecture 900 is provided for purposes of illustrating the underlying data architecture, which may be varied in design, layout, configuration, or elements (i.e., publisher website 902, widget 904, crawlers 906-910, crawled websites 912-926, and content 928-944) without limitation to the examples shown and described.

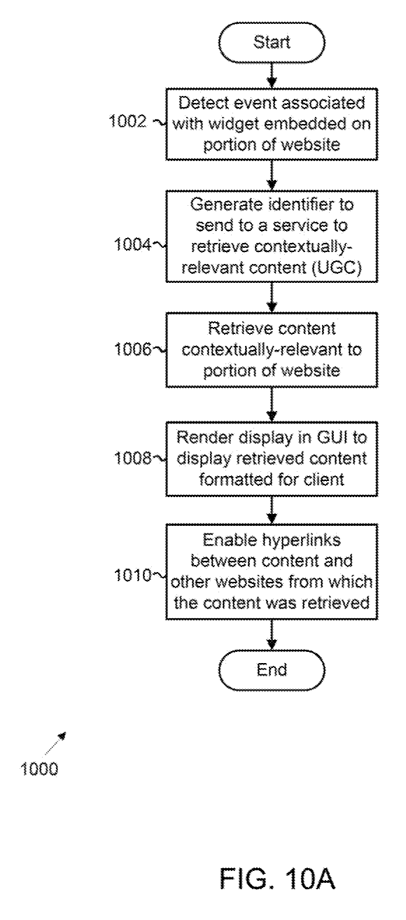

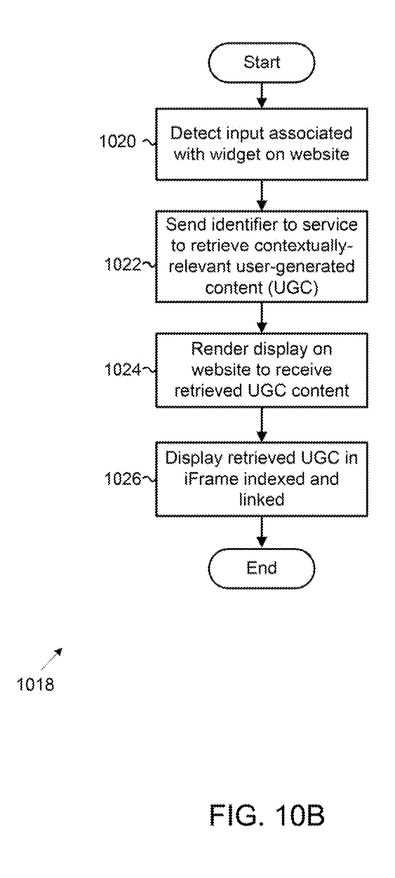

FIG. 10A illustrates an exemplary process for contextually-relevant user-generated data management. Here, process 1000 begins by detecting an event associated with a widget (e.g., widget 314 (FIG. 3A)) embedded on a website (or a portion thereof (e.g., on a page or sub-page of the website) (1002). When an event (e.g., mouse click, keyboard button depressed, pointer hover, and the like) is detected, an identifier is generated and sent to a service that is configured to perform the contextually-relevant user-generated content management techniques such as those described herein (1004). When the identifier is sent, content that is contextually-relevant is then retrieved by widget 314 for at least a portion of the website on which widget 314 is embedded (1006).

In some examples, retrieving content may be performed using various techniques. As an example, an identifier may be paired with information stored in databases 212 or 216 using product images, SKU, UPC, URLs, identifiers (product or services) to determine if a match has occurred. If a match occurs, the content is identified for transmission in response to widget 314. If a match does not occur, searching of databases 212 and 216 (or data repositories where content crawled by crawler servers. 206-210 is stored) continues until all content has been compared for purposes of pairing as described above. Other techniques for searching crawled content may be used and are not limited to those described above.

When content (e.g., UGC) is retrieved, a display (e.g., display 504 (FIG. 5)) is rendered in order to display the retrieved content (1008). In some examples, a display may be provided using an inline frame, JavaScript®, Cobra, HTML, HTML5, XML, or other programming or formatting languages, such as those described above and without limitation. While displaying content (or links thereto), hyperlinks and other features may be enabled for presentation and, if desired by a user, interaction within display 504 (1010). The above-described process may be varied in implementation, order, and other aspects and is not limited to the examples shown and described.

As an example, a user may be perusing a website that provides information and articles regarding small caliber weapons. While perusing a portion of the website (i.e., a web page), a user reads an article regarding a Model AR-15M4 assault rifle that she wishes to purchase. An icon representing widget 408 (FIG. 4) is placed immediately beneath the title of the article and, when the user selects the icon, a display, window, pop-up window, panel, or the like (e.g., display 504) is opened and numerous hyperlinks are provided, including hyperlinks to reviews regarding the performance of the item, defects, drawbacks, benefits, guides to state laws governing the sale of assault rifles, conventions and trade shows where the weapons may be tested, examined, and purchased, among other information. The placement, design, and layout of widget 408 may be varied, customized, or otherwise modified in order to integrate thematically with the website on which it is embedded or to accommodate requirements of publishers, merchants, advertisers, marketers, or others. When link is selected, display 504 may be varied to present a product review for the specific model from a website that is different than the one the user is navigating. Thus, contextual focus is retained while enabling a user to review content (e.g., a review of the weapon's performance) from another source in a contextual manner (i.e., displaying information without forcing a user to navigate away from a given web page) and, if she so decides, to engage in a transaction (e.g., purchase tickets to a gun show where Colt Arms Manufacturing, Inc. will be displaying the AR-15M4, locate a nearby gun shop, obtain a firearm permit, and the like). While only an example, the techniques described may be used for numerous and varied applications and are not limited to those shown and described.

FIG. 10B illustrates another exemplary process for contextually-relevant user-generated data management. As an alternative exemplary technique, process 1018 begins by detecting an input associated with a widget on a website (1020). After detecting the invocation of a widget (e.g., widget 314 (FIG. 3A)), an identifier is sent to a service to retrieve contextually-relevant user-generated content (1022). Once retrieved, a display (e.g., display 504 (FIG. 5)) is rendered on the website on which the widget is embedded prior to receiving the content (1024). As described above, various techniques may be used, including iframes, JavaScript®, or others, to generate one or more displays that are contextually presented (i.e., presented in an overlay, pop-up window, or display of data and information that does not interrupt the context of a current session, but instead augments the current session with additional, contextually-relevant content (e.g., UGC)). Once rendered, the display is populated with the retrieved content, which is indexed and hyperlinked (i.e., “linked”) to the source websites from which the content was, retrieved by crawlers (e.g., crawlers 206-210 (FIG. 2)) (1026). In other examples, the above-described process may be varied in implementation, order, and other aspects and is not limited to the examples shown and described.

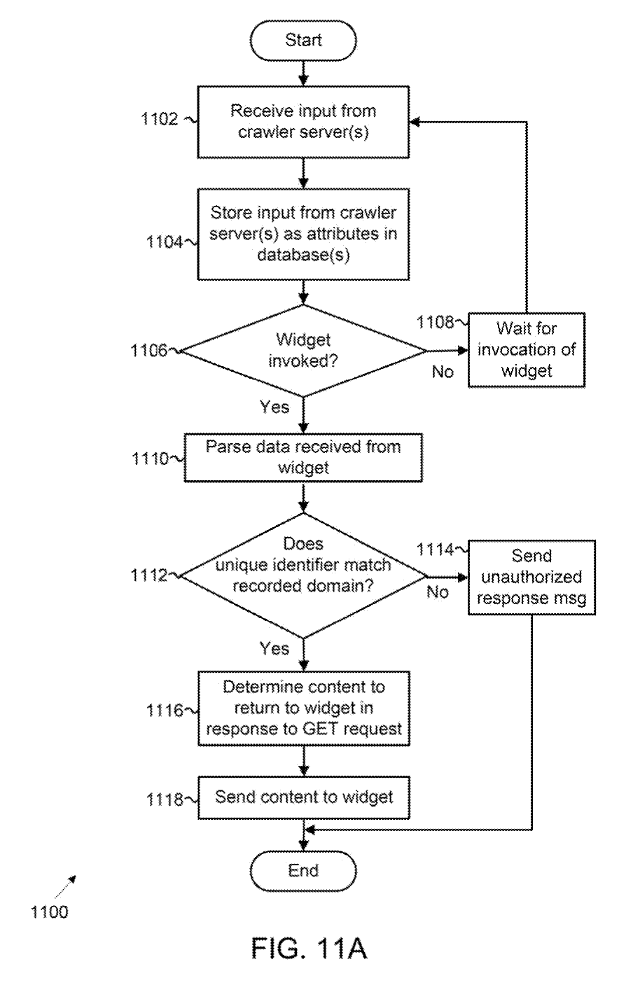

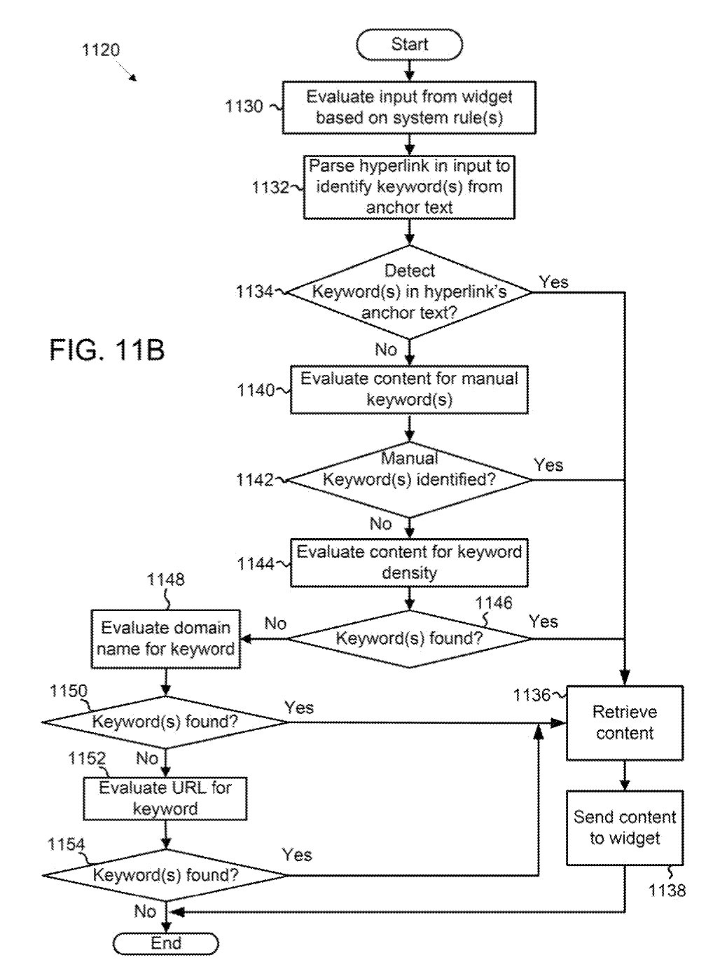

FIG. 11A illustrates a further exemplary process for contextually-relevant user-generated data management. Here, process 1100 begins by receiving an input from one or more crawler servers (e.g., crawler servers 206-210 (FIG. 2)) (1102). Input (i.e., content from crawler servers 206-210) is stored as attributes in a database (e.g., database 216) and indexed (i.e., storing indices in crawler index 212) (1104). A determination is then made as to whether a widget in data communication with the service described in this process is invoked (1106). If a widget (e.g., widget 314 (FIG. 3A)) is not invoked, the service then waits for a signal or data indicating the widget has been invoked and continues to receive and store input from crawler servers 206-210) (1108). If a widget has been invoked, then the data received from the widget is parsed (1110). By comparing data stored in database 216, a determination is made as to whether an identifier received from the widget matches with data stored (1112). If a match does not occur by comparing the (publisher, merchant, or website operator) unique identifier, then an unauthorized message is sent and further operations are halted (1114). If a match does occur, then the service determines content to be returned to the widget in response to a, for example, GET request for the desired content (1116). Once retrieved, using crawler index 212 and database 216, the content is then returned to the widget for display on a merchant, publisher, affiliate marketer, e-commerce seller, auction, or other type, of website on which widget 314 is embedded (1118). The above-described process may be varied in implementation, order, and other aspects and is not limited to the examples shown and described.

FIG. 11B illustrates yet another exemplary process for contextually-relevant user-generated data management. Here, process 1120 begins by evaluating input from a widget (e.g., widget 314 (FIG. 3A)) and subject to any system rules entered manually, automatically, semi-automatically, or otherwise (e.g., a website publisher wishes to have reviews from only certain websites, an e-commerce seller wishes to preclude product reviews for goods provided by competitors, etc.) (1130). A hyperlink included in the input from the widget is parsed to identify any keyword or set of keywords in the anchor text of the hyperlink (1132). A determination is then made as to whether a keyword is present in the hyperlink's anchor text (1134). If a keyword is present, then content (e.g., UGC) is retrieved (1136) and sent in response to the invoke message (i.e., input) of widget 314 (1138). If a keyword is not present in the hyperlink anchor text, then content on the website or web page where widget 314 is embedded is evaluated to identify any manual keywords that have been specified by the website publisher, operator, merchant, and the like (1140). A determination is made as to whether any manual keywords have been identified (1142). If manual keywords are identified, then content (e.g., UGC) is retrieved (1136) and sent in response to the invoke message (i.e., input) of widget 314 (1138). If manual keywords are not present then content on the website or web page on which widget 314 is embedded is evaluated for keyword density (1144). A determination is made as to whether a keyword is suggested by evaluating keyword density of the content of the website or web page (1146). If a keyword is identified based on keyword density, then content (e.g., UGC) is retrieved (1136) and sent in response to the invoke message (i.e., input) of widget 314 (1138). If keyword density evaluation does not yield a keyword, then a further evaluation is performed to determine if the domain name associated with the website indicates a keyword that be used to search for UGC (1148). Again, a determination is made as to whether a keyword is identified and, if so, content (e.g., UGC) is retrieved (1136) and sent in response to the invoke message (i.e., input) of widget 314 (1138) (1150). Subsequently, if no, keywords are found in the evaluation of the domain name, a further evaluation of the URL for the website or web page is performed (1152). A further determination is made as to whether a keyword is identified when evaluating the URL for the website or web page. If so, content (e.g., UGC) is retrieved (1136) and sent in response to the invoke message (i.e., input) of widget 314 (1138). If a keyword is not identified, then the process ends. If a keyword is identified, then content (e.g., UGC) is retrieved (1136) and sent in response to the invoke message (i.e., input) of widget 314 (1138). In some examples, publisher, merchant, or website operators may modify the above-described process 1120 by specifying areas of content on a website to be searched for purposes of generating an identifier that may be used to retrieve UGC and other content. In other examples, the above-described process may be varied in function, order, operation, or other aspects, without limitation to the descriptions provided.

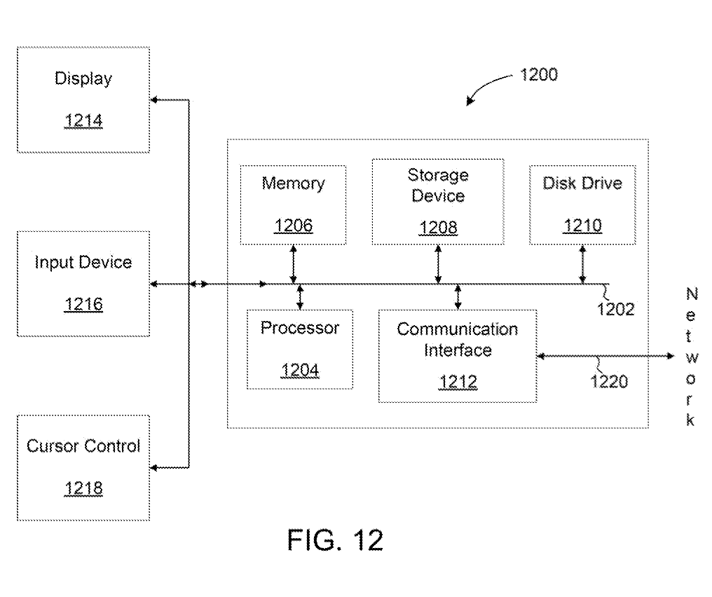

FIG. 12 illustrates an exemplary computer system suitable for contextually-relevant user-generated data management. In some examples, computer system 1200 may be used to implement computer programs, applications, methods, processes, or other software to perform the above-described techniques. Computer system 1200 includes a bus 1202 or other communication mechanism for communicating information, which interconnects subsystems and devices, such as processor 1204, system memory 1206 (e.g., RAM), storage device 1208 (e.g., ROM), disk drive 1210 (e.g., magnetic or optical), communication interface 1212 (e.g., modem or Ethernet card), display 1214 (e.g., CRT or LCD), input device 1216 (e.g., keyboard), and cursor control 1218 (e.g., mouse or trackball).

According to some examples, computer system 1200 performs specific operations by processor 1204 executing one or more sequences of one or more instructions stored in system memory 1206. Such instructions may be read into system memory 1206 from another computer readable medium, such as static storage device 1208 or disk drive 1210. In some examples, hard-wired circuitry may be used in place of or in combination with software instructions for implementation.

The term “computer readable medium” refers to any tangible medium that participates in providing instructions to processor 1204 for execution. Such a medium may take many forms, including but not limited to, non-volatile media and volatile media. Non-volatile media includes, for example, optical or magnetic disks, such as disk drive 1210. Volatile media includes dynamic memory, such as system memory 1206.

Common forms of computer readable media includes, for example, floppy disk, flexible disk, hard disk, magnetic tape, any other magnetic medium, CD-ROM, any other optical medium, punch cards; paper tape, any other physical medium with patterns of holes, RAM, PROM, EPROM, FLASH-EPROM, any other memory chip or cartridge, or any other medium from which a computer can read.

instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1202 for transmitting a computer data signal.

In some examples, execution of the sequences of instructions may be performed by a single computer system 1200. According to some examples, two or more computer systems 1200 coupled by communication link 1220 (e.g., LAN, PSTN, or wireless network) may perform the sequence of instructions in coordination with one another. Computer system 1200 may transmit and receive messages, data, and instructions, including program, i.e., application code, through communication link 1220 and communication interface 1212. Received program code may be executed by processor 1204 as it is received, and/or stored in disk drive 1210, or other non-volatile storage for later execution.

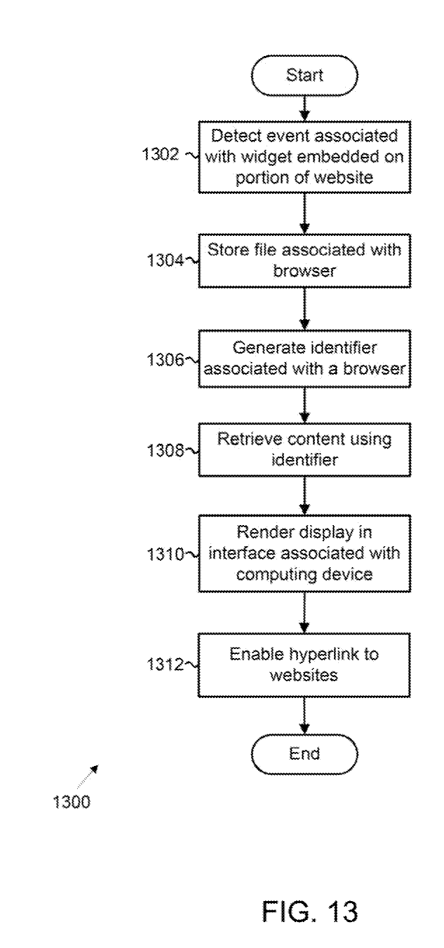

FIG. 13 illustrates an exemplary process for retargeting contextually relevant user-generated data. Here, process 1300 begins by detecting an event associated with a widget embedded on at least a portion of a website (1302). Once detected, a file (e.g., cookie) may also be stored on a system such as a computing device or operating system in order to collect data associated with the behavior, history, or other characteristics of a browser (1304). Once stored, the data in a cookie may be retrieved and used to generate an identifier associated with a browser (1306). As described herein, the data may indicate when a user has navigated from one website to another and, by analyzing or evaluating the pattern of behavior and identifying common keywords between the multiple locations, content may be identified. Using the identified common keywords, subsequent content may be retrieved from a database (e.g., database 216 (FIG. 3C)) and retargeted to a user who may be navigating a browser to a different website to research a given item of interest.

Using the identifier, which may be configured to use keywords, sentiment factors (i.e., factors), or other attributes, content may be retrieved (1308). Once retrieved, content may be rendered in a display in an interface on computing device (1310). In some examples, an interface may be a browser, pop-up window, or other type of display that may be configured to be presented on a computing device in a manner that does not disrupt the experience of a user, but instead augments or is contextually relevant to her current activities. Once rendered, hyperlinks may be enabled within the content (e.g., reviews) to enable a user, if she desires, to “click through” to a website, address, or destination to read a contextually-relevant review, product information, engage in a transaction to purchase an item, or perform other actions, without limitation (1312). In other examples, the above-described process may be varied in function, order, operation, or other aspects, without limitation to the descriptions provided.

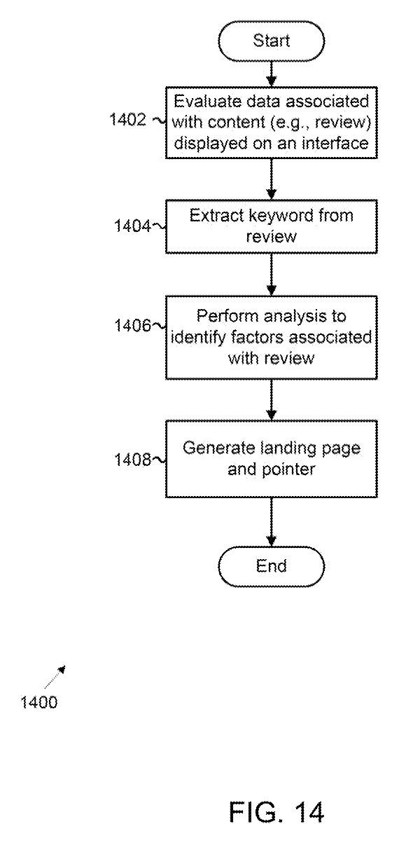

FIG. 14 illustrates an exemplary process for sentiment and factor-based analysis in contextually-relevant user-generated data management. Here, process 1400 begins by evaluating data associated with content such as a review displayed on an interface (1402). Keywords identified by evaluating data associated with the content or review may be extracted (1404). Once extracted, sentiment analysis may be performed to identify one or more factors (e.g., sentiment factors or attributes that describe a given user's predilection, preference, affinity, or emotional associations with an item, service, or the like (1406). Once determined, factors may be used to generate a landing page that is configured to aggregate content based on the factors (1408). For example, a landing page (e.g., website or web page) may be generated and configured to present reviews of a given item in descending order of preference based on users' affinities and purchase histories of the item. As an example, if a user were performing research on a type of office chair on a website and, based on evaluating product reviews, determines that the type of chair being sought is frequently associated with the keyword “chair” and a sentiment factor of “comfortable,” then a term may be created that combines these results (e.g., “comfortable chair”) and used to aggregate other reviews that match or substantially match this term. Further, the landing page may have an address, pointer, or URL that includes the term “comfortablechair” such that a user, when selecting a given review, is directed to a landing page that aggregates and lists reviews of items that are determined to statistically or programmatically match the term. Other variations and examples may be designed or implemented and are not limited to those presented and described. In other examples, the above-described process may be varied in function, order, operation, or other aspects, without limitation to the descriptions provided.

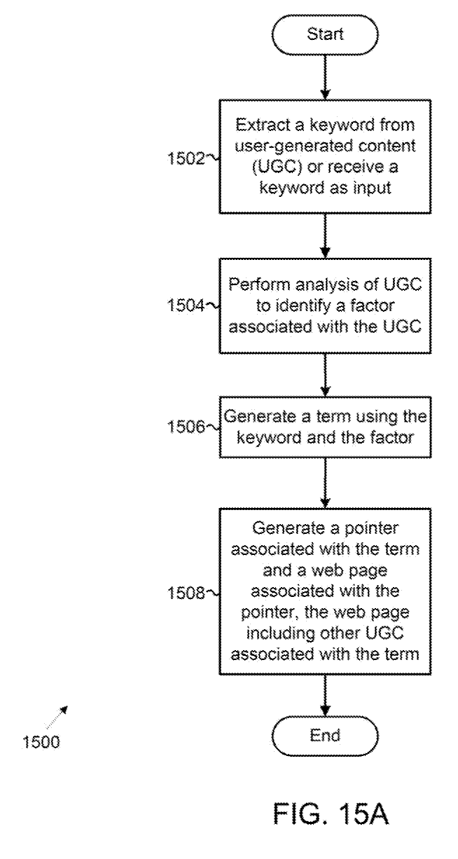

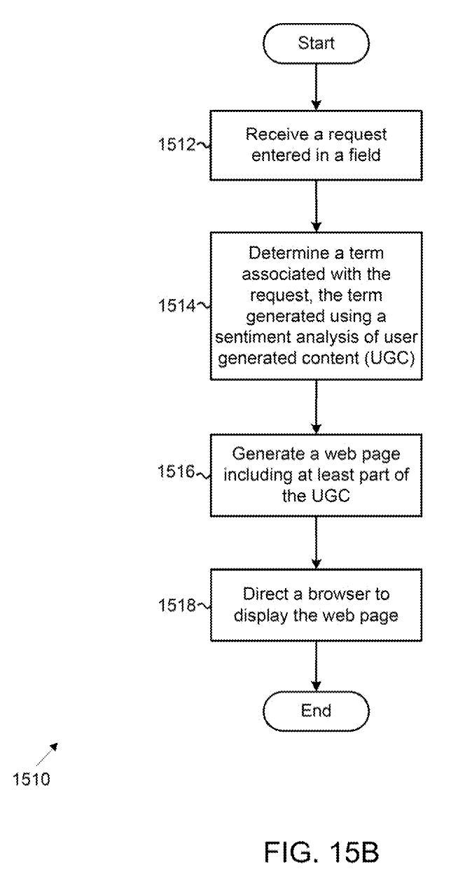

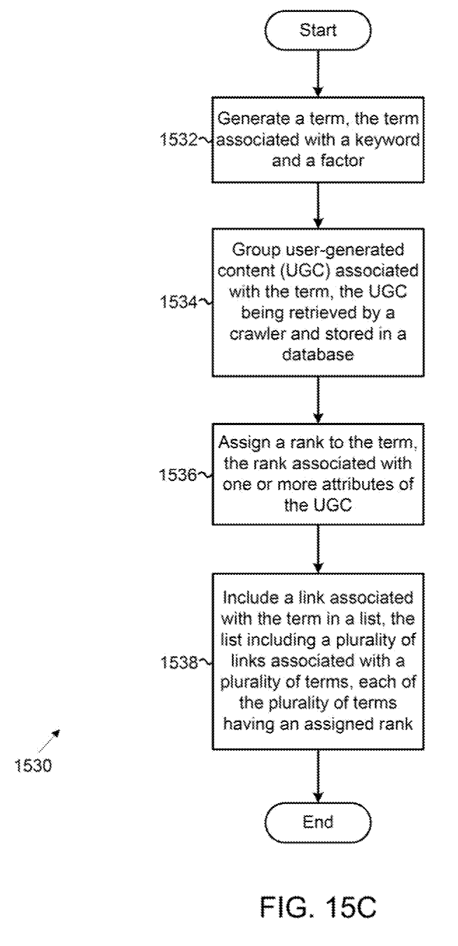

FIG. 15A illustrates an exemplary process for providing sentiment-related content using sentiment and factor-based analysis in contextually-relevant user-generated data management. Here, process 1500 begins with extracting a keyword from user-generated content or receiving a keyword as input (1502). In some examples, a keyword may be extracted from user-generated content as described above in detail. In other examples, a keyword may be received as input, for example, as part of a request (e.g, a phrase, product category, product title, question, search term, or other request, without limitation) entered into a field by a user, as described herein. In still other examples, a keyword may be obtained or identified using other techniques.

Once a keyword has been extracted or received, an analysis of user-generated content may be performed to identify a factor associated with user-generated content (1504). For example, an analysis may be a sentiment analysis (e.g., using NLP) to identify one or more factors (e.g., sentiments) associated with user-generated content (e.g., one or more reviews). In some examples, the sentiment analysis may be carried out using sentiment analysis engine 352, as described herein. For example, based upon reviews of a given product, sentiment analysis engine 352 and keyword module 310 may be used to create or generate a term that relates to a sentiment expressed in reviews associated with the given product (e.g., “cute toy,” “inexpensive toy,” “reliable laptop,” “faulty components,” “healthy glow,” “fake stainless steel,” “repetitive songs,” “good battery life,” “free delivery,” and other terms, without limitation). In some examples, a factor may be determined to be associated with the user-generated content if the factor itself is expressed in the user-generated content (e.g., one or more reviews mentions the factor (e.g., “comfortable,” “nice,” “warm,” “cool,” “hot,” “great,” “poor,” “healthy,” “reliable,” “classy,” “powerful,” “easy,” “inexpensive,” “pricy,” “faulty,” “loud,” “defective,” “slow,” “cute,” “durable,” “chunky,” “clunky,” “strong,” or other attributes, without limitation)). In other examples, a factor may be determined to be associated with the user-generated content if the user-generated content expresses another sentiment that is determined to statistically or programmatically match the factor (e.g., expressed as a synonym of, a misspelling of, or otherwise similar to or matching, the factor).

After a factor is identified, a term is generated using the keyword and the factor (1506). In some examples, the term may be generated as a combination of the keyword and the factor (e.g., “cute toy,” “inexpensive toy,” “reliable laptop,” “faulty components,” “healthy glow,” “fake stainless steel,” “repetitive songs,” “good battery life,” “free delivery,” or other terms, without limitation). In some examples, the term (and other terms generated by this process) may be stored in a database (e.g., in database 212 and/or 216) along with user-generated content that is determined to be associated with the term. After the term is generated, a pointer associated with the term and a web page associated with the pointer also may be generated, the web page including other user-generated content associated with the term (1508). In some examples, the web page may be configured to show both the user-generated content from which the factor was identified in addition to the other user-generated content previously determined to be associated with the term. In some examples, the other user-generated content may have been previously associated with the term, for example, after determining that the other user-generated content also included an expression of the term, or was otherwise statistically or programmatically matched (e.g., algorithmically) with the term. For example, the other user-generated content may be previously grouped, and stored in a database (e.g., database 212 or 216) as a group. In some examples, the stored groups may be tagged or otherwise identified as being associated with the term. In such cases, generating the web page may include accessing the group (i.e., of user-generated content) identified as being associated with the term and presenting the group, or at least part of the group (i.e., some of the user-generated content), on the web page.

In other examples, the web page further may be configured to show other contextually-relevant data relevant to the term (e.g., data related to products associated with the user-generated content and the other user-generated content, or other data). In some examples, process 1500 further may include directing a browser to display the web page, for example, upon detection of an event (e.g., a selection of a link (e.g., hyperlink) associated with a pointer (e.g., the pointer being associated with the term) in a user interface or browser). In some examples, the web page may be configured to enable a user to compare two or more products based upon “positive,” “neutral,” and “negative” sentiments expressed in reviews for the two or more products. It may be appreciated that a sentiment may be qualitatively characterized as “positive,” “neutral” or “negative” using a variety of bases, and that the same sentiment may be characterized differently for different purposes. In an example, a web page may display links (e.g., anchor text of hyperlinks showing the term (e.g., keyword—factor) associated with each link) on one side associated with “positive” sentiments in reviews for a given product, and links on another side associated with negative sentiments in reviews for the given product. In some examples, the web page may display the text of reviews in full or in part (e.g., blurbs, snippets, or other text) underneath each link. In this example, the links may enable a user to navigate to another web page displaying the full text of the reviews, or additional related reviews. In some examples, these additional reviews may be for related or similar products for which reviewers have expressed the same or similar sentiments. Other variations and examples may be designed or implemented and are not limited to those presented and described. In other examples, the above-described process may be varied in function, order, operation, or other aspects, without limitation to the descriptions provided.

FIG. 15B illustrates an alternative exemplary process for providing sentiment-related content using sentiment and factor-based analysis in contextually-relevant user-generated data management. Here, process 1510 begins with receiving a request entered in a field (1512). In some examples, the field may be presented by a user interface, for example, using a browser. In other examples, the user interface may present the field in a separate application (e.g., a mobile application, or other application, without limitation). In some examples, the field may be a search field. In some examples, the request being entered may be a phrase, keyword, question, or other input. Once the request is received, a term associated with the request may be determined, the term generated using a sentiment analysis of user-generated content (1514). In some examples, the sentiment analysis of the user-generated content (e.g., one or more reviews, or other contextually-relevant data associated with one or more products) may be carried out using sentiment analysis engine 352, as described herein. In some examples, a term may be deemed to be associated with the request if the term and the request share one or more keywords, or are otherwise statistically or programmatically matched (e.g., algorithmically). In other examples, the request may include an expression of a sentiment that also is expressed in at least part of the user-generated content (e.g., in at least one review). In some examples, the sentiment analysis may include NLP of the user-generated content. In some examples, the term and other terms may be stored in a database (e.g., databases 212 and/or 216).

After the term associated with the request is determined, a web page is generated including at least part of the user-generated content, for example, the part of the user-generated content being associated with the term (1516). In some examples, the part of the user-generated content may include a subset of the user-generated content (e.g., a subset of reviews) that was analyzed to generate the term. For example, a subset of the reviews that correlate (e.g., based on keyword density or otherwise determined using statistical or programmatic algorithmic analysis) with the term may be aggregated on the web page. In some examples, the subset of the user-generated content that correlates with the term may be previously grouped, and stored in a database (e.g., database 212 or 216) as a group. In some examples, the stored groups may be tagged or otherwise identified as being associated with the term. In such cases, generating the web page may include accessing the group and presenting the group, or at least part of the group (i.e., some of the user-generated content), on the web page. In some examples, the web page may display the at least part of the user-generated content (e.g., subset of reviews) in full. In other examples, the web page may display only a part of the subset of reviews (e.g., blurbs or snippets of one or more of the reviews) and provide a link associated with a pointer for another web page that may display the reviews in full. In other examples, the web page also may include links to other web pages that include other contextually-relevant data (e.g., associated with other products in the same category or products matching similar sentiments). Once the web page is generated, a browser may be directed to display the web page (1518). In some examples, the web page may be displayed using the same browser window that presented the field in which the request was entered, and the browser is directed to the web page including the at least part of the user-generated content in response to the entry of the request. In other examples, a separate browser or browser window (e.g., pop-up, or other window) may appear in response to the entry of the request to display the web page. In some examples, the web page may be configured to enable a user to compare two or more products based upon “positive,” “neutral,” and “negative” sentiments expressed in reviews for the two or more products, as described herein. Other variations and examples may be designed or implemented and are not limited to those presented and described. In other examples, the above-described process may be varied in function, order, operation, or other aspects, without limitation to the descriptions provided.

FIG. 15C illustrates an exemplary process for generating a ranked list of terms using sentiment and factor-based analysis in contextually-relevant user-generated data management. Here, process 1530 may begin with generating a term, the term associated with a keyword and a factor. In some examples, a keyword may be extracted from user generated content, as described herein. In other examples, a keyword may be received as input, as described herein. In still other examples, a keyword may be obtained or identified using other techniques.

In some examples, a factor may be identified using sentiment analysis (e.g., as performed by sentiment analysis engine 352), as described herein. Once the term is generated, user-generated content associated with the term may be grouped, the user-generated content being retrieved by a crawler and stored in a database (1534). In some examples, the user-generated content may include one or more reviews. In other examples, the user-generated content, or other contextually-relevant data, may be previously grouped and associated with the term. Such previously grouped user-generated content may be stored in a database (e.g., database 212 or 216) and tagged, or otherwise identified, as being associated with the term.

Once the user-generated content associated with the term has been grouped, or a stored group of user-generated content has been identified as being associated with the term, a rank may be assigned to the term, the rank associated with one or more attributes of the user-generated content (1536). In some examples, the rank may be a number representing a weighing of various factors or attributes associated with the user-generated content (e.g., keyword density, star ratings, number of reviews associated with the term, “positive,” “neutral,” or “negative” sentiment of reviews, length of reviews, date of reviews, or other user-generated content-related factors or attributes, without limitation) or other types of factors or attributes (e.g., location of a reviewer, other user-related information (e.g., stored in a cookie, as described herein), or others, without limitation). For example, the term “healthy glow” may be assigned a higher ranking than the term “expensive toy” based upon various factors or attributes of the user-generated content, or other factors associated with the user, that expresses these respective terms. In this example, the term “healthy glow” may be expressed in, and thereby associated with, a higher number of reviews, it may be deemed to be a “positive” sentiment, it may be very densely expressed in reviews, it may have been included in more recent reviews, or for other reasons be deemed to be a term of more interest or use to the user (e.g., previous behavior of the user indicates the user has a history of buying the types of products associated with the term “healthy glow,” or other reasons). In this example, the term “expensive toy” may be expressed in a fewer number of reviews, it may be deemed to be a “negative” sentiment, it may have been less densely expressed in said reviews, it may have been included in older reviews, or for other reasons be deemed to be a term of less interest or use to the user. In another example, the term “expensive toy” may be assigned a higher ranking than the term “healthy glow” where the different factors or attributes weigh more heavily in favor of the term “expensive toy” (e.g., even if deemed to be a “negative” sentiment, the user may have a history of purchasing products associated with user-generated content expressing “expensive toy,” but not products associated with user-generated content expressing “healthy glow,” and other factors associated with “expensive toy” may favor a higher ranking). It may be appreciated that rankings may be assigned using a variety of different algorithms, including various techniques for weighing factors and attributes, without limitation. Once a rank is assigned to the term, a link associated with the term may be included in a list, the list including a plurality of links associated with a plurality of terms, each of the plurality of terms having an assigned rank (1538). For example, once a rank is assigned to the terms “healthy glow” and “expensive toy,” a link may be created for each term, associated with its respective term, and included in a list according to its respective rank. In some examples, the list already may be populated with other links for other terms, and already may be ordered by rank (e.g., in numerical order of rank), in which case the links for the terms “healthy glow” and “expensive toy” may be added to (i.e., inserted into) the list according to their respective ranks. In other examples, other aspects of, or items (e.g., products, services, or other items) associated with, user-generated content may be ranked using the same or substantially similar techniques.

In some examples, the link may be implemented as a hyperlink, as described herein. In other examples, the list of links may be stored in a database (e.g., database 212 or 216), along with an indication (e.g., tag or other indication) of the assigned rank of the term with which each link is associated. In some examples, all or part of the list of links may be presented on a web page as a tool for a user to discover products or services through the sentiments expressed iii the user-generated content (e.g., reviews) for those products or services. For example, on a web page displaying contextually-relevant user-generated content (e.g., the web pages described with reference to FIGS. 15A and 15B, or other web pages), there may be a widget or feature on the web page providing a predetermined number of links, listed in order of their rank (i.e., the rank assigned to the term associated with the link), each link configured to enable a user to navigate to another web page. In some examples, the another web page may be displayed in the current browser window, in a pop-up window, or other browser window, and may display other contextually-relevant user-generated content. In other examples, a web page displaying contextually-relevant user-generated content may display none of the list of links. In other examples, rankings of other aspects of, or items (e.g., products, services, or other items) associated with, user-generated content may be stored and displayed using the same or substantially similar techniques. Other variations and examples may be designed or implemented and are not limited to those presented and described. In other examples, the above-described process may be varied in function, order, operation, or other aspects, without limitation to the descriptions provided.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method, comprising:
generating a term, the term associated with a keyword and a factor;
grouping user-generated content associated with the term, the user-generated content being retrieved by a crawler and stored in a database;
assigning a rank to the term, the rank associated with one or more attributes of the user-generated content; and
including a link associated with the term in a list, the list comprising a plurality of links associated with a plurality of terms, each of the plurality of terms having an assigned rank.

2. The method of claim 1, wherein each of the plurality of links is associated with one of the plurality of terms.

3. The method of claim 1, further comprising displaying at least part of the list on a web page.

4. The method of claim 3, wherein the at least part of the list comprises two or more of the plurality of links displayed in order of the assigned rank for each of the two or more of the plurality of links.

5. The method of claim 1, wherein the link is placed in the list according to the rank.

6. The method of claim 1, wherein the one or more attributes comprises a star rating provided in the user-generated content.

7. The method of claim 1, wherein the one or more attributes comprises a density of the keyword in the user-generated content.

8. The method of claim 1, wherein the one or more attributes comprises, a number of, reviews associated with the term.

9. The method of claim 1, wherein generating the term comprises performing a sentiment analysis to identify the factor.

10. The method of claim 1, wherein generating the term comprises extracting the keyword from the user-generated content.

11. The method of claim 1, wherein generating the term comprises receiving a request being entered in a field, the request associated with the term.

12. The method of claim 1, further comprising directing a browser to display a web page comprising at least part of the user-generated content when an event is detected, the event comprising a selection of the link.

13. The method of claim 1, wherein the user-generated content comprises one or more reviews.

14. A system, comprising:
a memory configured to store user-generated content;
a processor configured to generate a term, the term associated with a keyword and a factor, group user-generated content associated with the term, the user-generated content being retrieved by a crawler and stored in a database, assign a rank to the term, the rank associated with one or more attributes of the user-generated content, and include a link associated with the term in a list, the list comprising a plurality of links associated with a plurality of terms, each of the plurality of terms having an assigned rank; and
a user interface configured to present at least part of the list.

15. The system of claim 14, wherein the user interface further is configured to present the at least part of the list in order of the assigned rank.

16. The system of claim 14, further comprising a sentiment analysis engine configured to perform an analysis of the user-generated content to identify the factor.

17. The system of claim 16, wherein the sentiment analysis, engine is configured to perform natural language processing.

18. The system of claim 14, further comprising one or more databases configured to store the term and the list.

19. A computer program product embodied in a computer readable medium and comprising computer instructions for:
generating a term, the term associated with a keyword and a factor;
grouping user-generated content associated with the term, the user-generated content being retrieved by a crawler and stored in a database;
assigning a rank to the term, the rank associated with one or more attributes of the user-generated content; and
including a link associated with the term in a list, the list comprising a plurality of links associated with a plurality of terms, each of the plurality of terms having an assigned rank.
